(19) United States
(12) Patent Application Publication
(10) Pub. No.: US 2010/0206496 A1
(43) Pub. Date: Aug. 19, 2010

(54) STRETCHER TO BE USED, IN PARTICULAR, FOR CANVAS

(76) Inventor: Johannes Hendrikus Ninaber, Oss (NL)

Correspondence Address: ROBERT M. MCDERMOTT, ESQ., 1824 FEDERAL FARM ROAD, MONTROSS, VA, 22520, US

(21) Appl. No.: 12/682,304

(22) PCT Filed: Oct. 15, 2008
(86) PCT No.: PCT/NL2008/000226

§ 371 Date: Apr. 9, 2010

(30) Foreign Application Priority Data
Oct. 16, 2007 (NL) NL1034525
Nov. 28, 2007 (NL) NL1034769

(51) Int. Cl. B44D 3/18

(52) U.S. Cl. 160/372; 160/378; 160/405

(57) ABSTRACT

A stretcher comprises frame sections. The frame sections comprise two extruded profiles (B, D) whereby the outer profile is made of a softer material than the inner profile. The inner, hard profile (D) gives firmness to the stretcher, while the softer profile (B) provides flexibility. The softer profile is fitted with a flexible wall that can hinge around a hinge line. This makes it possible to accommodate variations in canvas tension, while at the same time ensuring a strong stretcher. The frame sections are fitted with adjustment mechanisms-(F, L).

The invention relates to a stretcher for canvas, comprising a number of frame sections.

The invention also relates to a method for fabricating a frame section for a stretcher for painting canvas.

Conventional and still generally used methods for fixing sagging canvas rely on a canvas tensioning frame, whereby the tips of the four wooden or partly metal frame sections are equipped with corner joints.

These types of stretchers are known from for instance French Patent number 439638 (Vidal) and European Patent Number 0102922 (Staro).

The canvas is laid over the stretcher and generally tensioned and subsequently fastened to the stretcher in one or other manner.

This generally involves wooden frame sections and the use of staples. The frame sections should meet a number of requirements. They should be strong and offer sufficient stiffness to maintain their shape while accommodating the force of the tensioned canvas.

Additionally, they may not damage the canvas. The frame sections are preferably easy to fabricate.

The canvas can preferably be tensioned reversibly in an easy and controlled manner and easily attached to the frame section.

It is an object of the invention to provide a stretcher containing frame sections that are easy to produce, and also offer a high degree of flexibility in terms of design and properties.

To this end, the stretcher according to the invention is characterised in that the frame section contains at least a first and second profile made of extruded material, whereby the materials of said profiles differ from one another, the profiles are locked into one another in a longitudinal direction, the first profile extends beyond the outer edge of the stretcher and the second profile is positioned more inward, whereby the first profile is made of a softer material than the second profile.

The production of frame sections made of extrusion profiles is a known process.

Various requirements are to bet met for a frame section, however. The frame sections should, on the one hand, be sufficiently strong to provide stiffness to the stretcher, but should also be flexible enough to accommodate tension changes in the canvas and ensure that the canvas that is stretched over the edge of the frame section is not damaged. The canvas is preferably attached to the frame section.

By having the frame section comprise two (or more) profiles of different extruded materials, which are locked to one another in the longitudinal direction of the frame section, the properties of the various profiles of the frame section can be chosen in a controlled manner. By making a first profile, positioned on the outside of the frame section, of a softer material than the second—inner—profile, the framework of the frame section is given both stiffness due to the strength of the inner-oriented second profile, while damage to the canvas is reduced and tension changes are better accommodated by the softness and flexibility of the first profile positioned along the outside.

The profiles can be extruded separately and subsequently locked together or preferably produced by means of co-extrusion.

The extrusion profiles can differ from one another in terms of physical properties such as surface roughness. Surface roughness is of importance, for example, in preventing damage to the canvas (on the edge over which the canvas is drawn) or to hold a canvas (at the position where the canvas is clamped or stapled).

The harder extrusion profile provides stiffness to the framework of the frame section. The outer extrusion profile is made of a softer material. These softer extrusion profiles can be used to accommodate the tension in the canvas or to attach the canvas, e.g., in a preferred embodiment by stapling to the framework, in those cases that the harder material of the hard extrusion profile would not allow such a function. The softer extrusion profile is preferably provided with an edge along which the canvas is guided, as well as a flexible outer edge. A flexible outer edge allows for good tension accommodation.

The softness of the material of the first profile reduces the risk of damage to the canvas while the flexible edge will come under a certain degree of tension and follow the movement during the tensioning process. Changes in canvas tension, whether an increase (stretching), or a decrease (sagging), will be partly compensated by an elastic movement of the flexible wall to the inside or outside.

In a preferred embodiment, the frame section contains adjustment mechanisms for moving the flexible wall in a direction at right angles to an outer edge of the stretcher to enable movement of the flexible wall.

By using two or more broad or narrow flexible profiles on the same hard frame section, it is possible to vary the thickness of the total frame section. Also, in case larger stretcher dimensions are required, the hard frame section, which serves as the framework, can be exchanged for a heavier profile in order to enable the stretching of larger surfaces. The profiles are also referred to below as extrusion profiles as they contain a profile and have been produced by means of an extrusion process.

These, and further, aspects of this invention are described and illustrated below.

In this

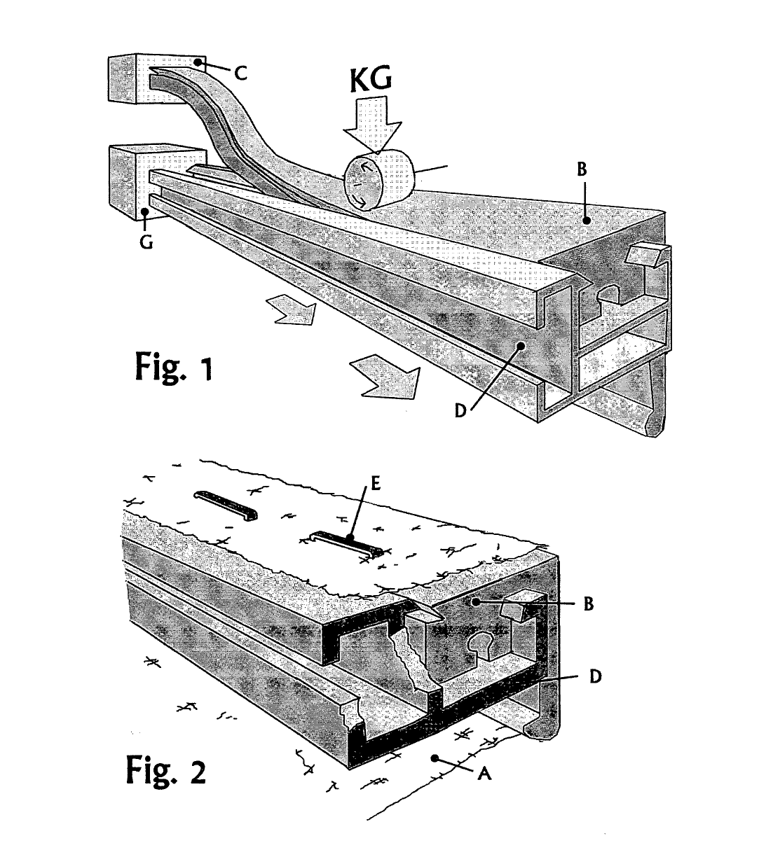

FIG. 1 shows an example of a frame section according to the invention containing two extrusion profiles that lock into one another.

FIG. 2 shows a detail of a stretcher according to the invention in which the canvas is stapled into one of the extrusion profiles.

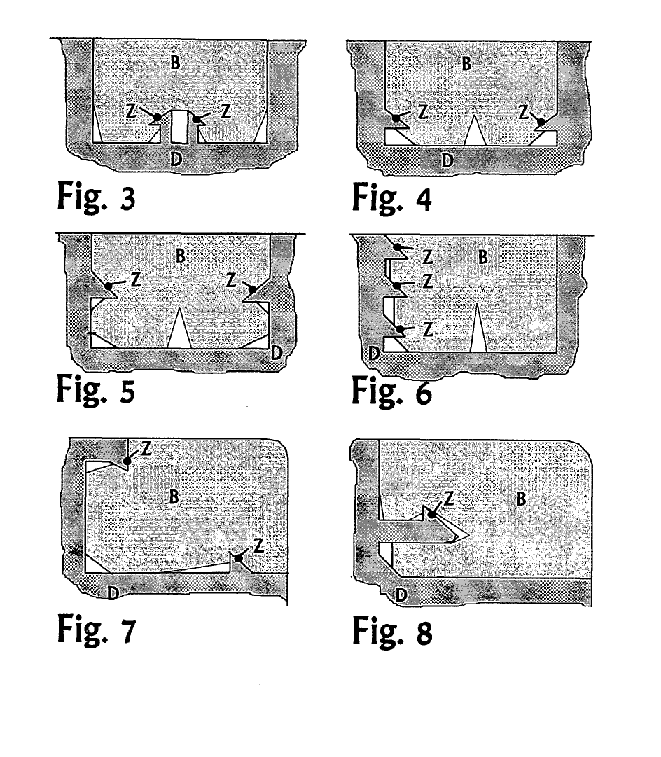

FIGS. 3 thru 8 show details of a number of embodiments of a frame section according to the invention in which the extrusion profiles lock into one another.

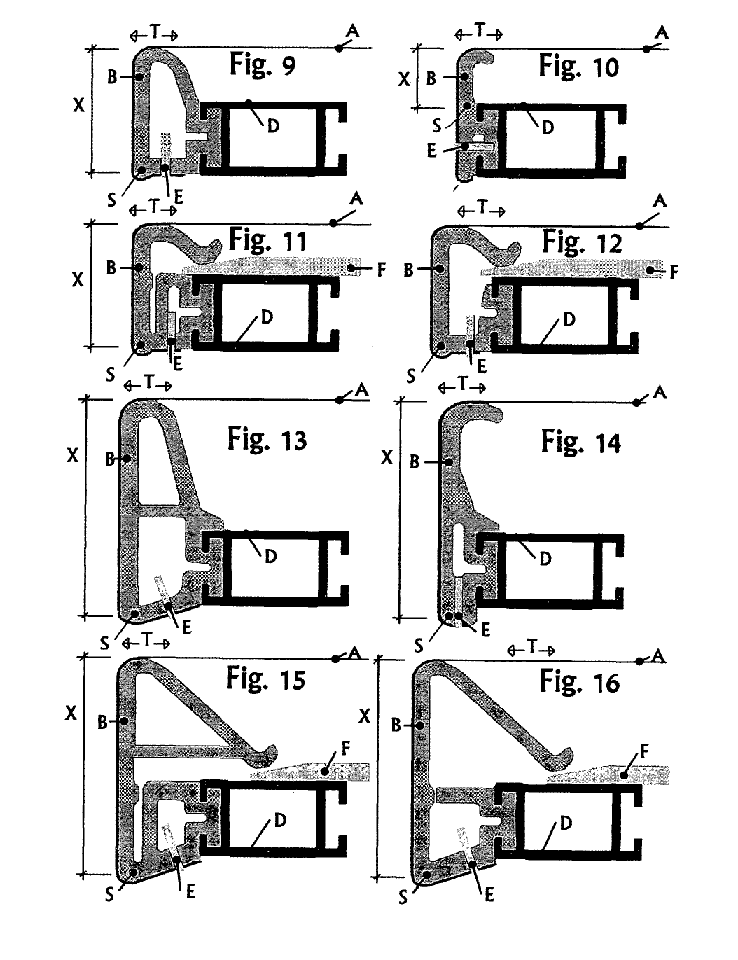

FIGS. 9 thru 16 show various embodiments in which a harder exclusion profile is used on the inside of the frame section and a softer extrusion profile on the outside.

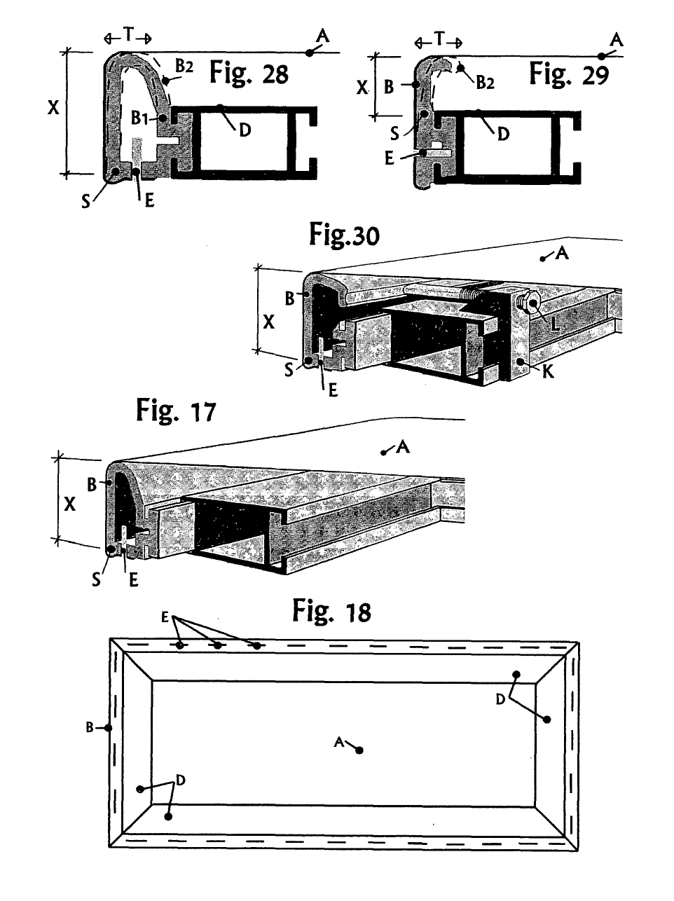

FIG. 17 shows a cross-section of a stretcher with canvas.

FIG. 18 shows a rear view of a stretcher with canvas.

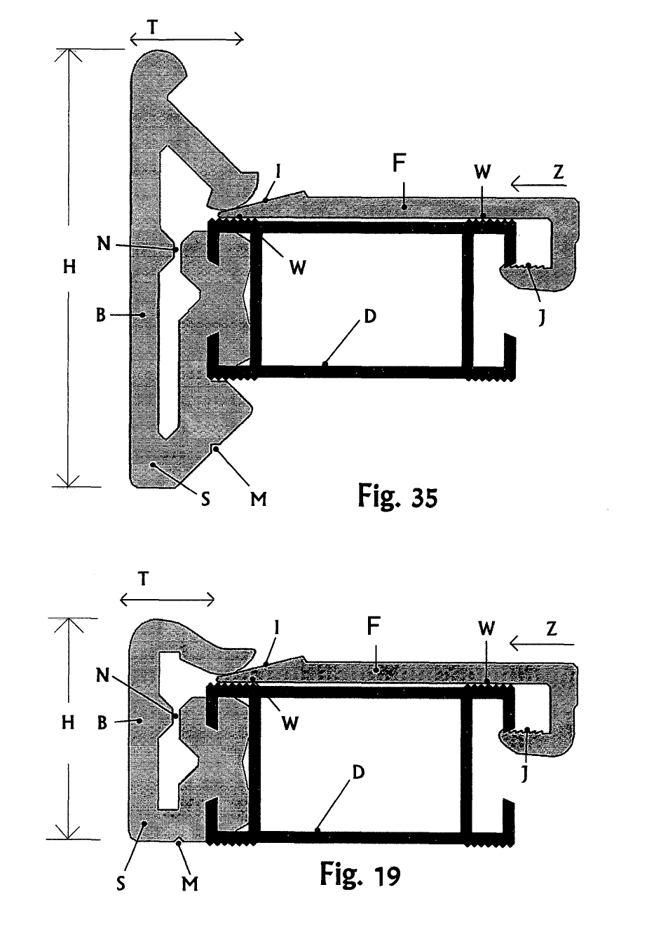

FIGS. 19 thru 27 are further cross-section views of frame sections according to the invention.

FIGS. 28 and 29 illustrate the flexible character of the flexible wall.

FIG. 30 shows a further embodiment.

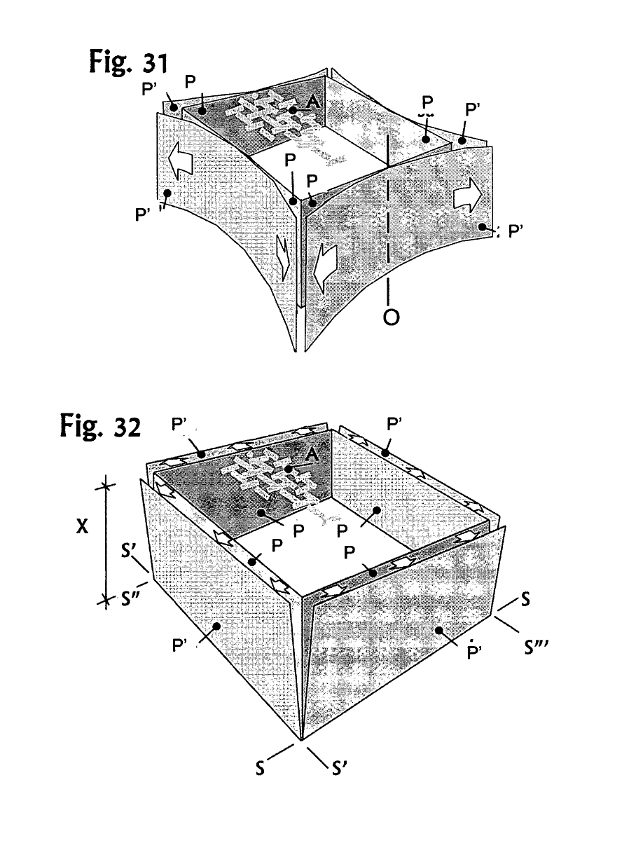

FIGS. 31 and 32 show the effect of a embodiment of the invention.

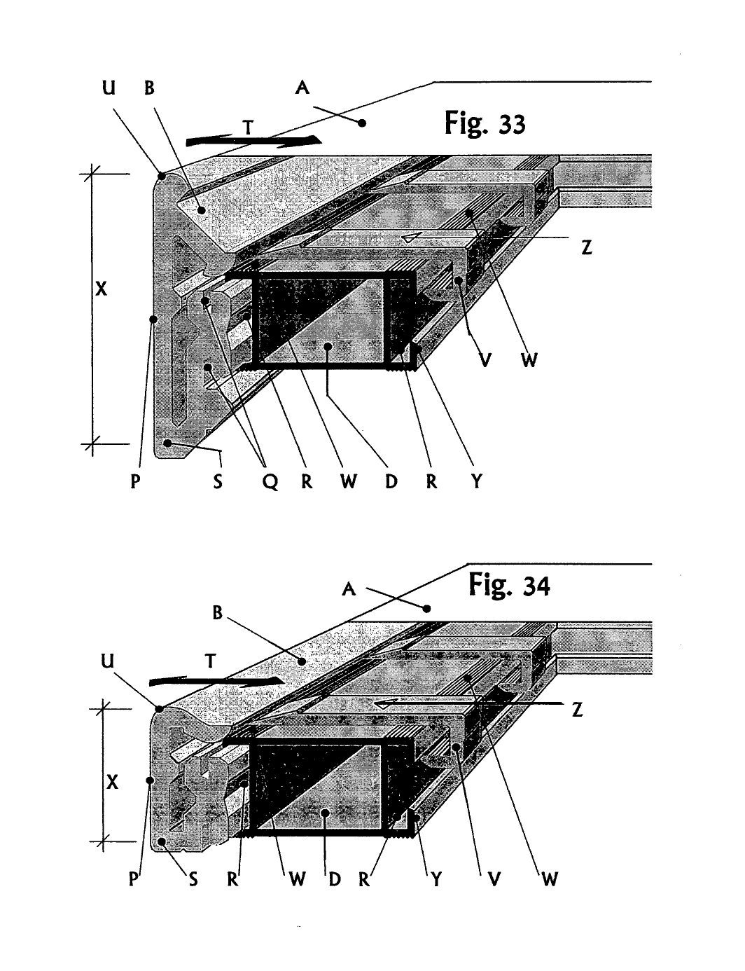

FIGS. 33, 34, 35 and 36 show further embodiments of a frame section according to the invention.

The figures are examples only, comparable components are in general indicated by means of the same number.

FIG. 1 schematically shows two extrusion nozzles C and G from which two extrusion profiles B and D are pressed. Extrusion profile B forms the first element of a frame section, extrusion profile D the second, harder element. In this example, extrusion profile D is made of a relatively hard extrusion material and extrusion profile B is made of a relatively soft extrusion material. Extrusion materials include plastic and aluminium. The extrusion material of the second profile D, which forms the framework of the frame section, is preferably made of aluminium or aluminium alloy, while the extrusion material of the first profile B is made of a plastic such as PVC. Extrusion profile D is provided in this example with an internal space that, in terms of shape, more or less corresponds with a part of the external shape of at least a part of extrusion profile B. Extrusion profile B is pressed into this space. That is shown in the drawings by means of a roller that exudes a force (KG) in order to press extrusion profile B into extrusion profile D. In this example, these profiles are pressed into one another shortly after extrusion, after which the combination can be sawn to length. Obviously, both extrusion profiles can first be made to length individually, after which extrusion profile B is pressed into extrusion profile D. The harder extrusion profile D extends partly beyond the inner edge of the frame section, the softer extrusion profile B extends beyond the outer edge of the frame section. In this example, extrusion profiles B and D are extruded separately. The invention also allows for the production of profiles by co-extrusion.

FIG. 2 shows how a canvas (A) is placed around the combined structure of extrusion profiles B and D. The canvas is stretched over the outer edge and over the softer, more flexible extrusion B. Canvas A is usually tensioned. The canvas is subsequently attached by means of staples (E) or other fastening materials such as screws, nails or clamps. The combined structure of extrusion profiles with different properties has the advantage that the hard extrusion profile D gives firmness to the stretcher. The problem with a hard material is that it does not allow easy penetration by staples, screws, nails, etc. This is easier in case of a softer plastic material. Besides the aforementioned advantages, the use of extrusion profiles also offers the benefit, as compared with wood, chipboard and MDF (medium density fibre board) that the extrusion materials, commonly plastic and aluminium, are easy to process and show little to no response to moisture, ensuring a stable frame section and stretcher that will not warp or expand when exposed to moisture.

In preferred embodiments, one extrusion profile contains a slot in which part of the other extrusion profile can be fitted, whereby the inside space is preferably provided with sawteeth to ensure a strong bond between the two extrusion profiles.

FIGS. 3 thru 8 show various embodiments of this. Various versions of sawteeth (Z) are shown. The sawteeth provide a strong bond with the inserted profile.

The second part, i.e. the extrusion profile made of a harder material, is preferably provided with a slot or a protruding rail on which the other profile can be pressed.

The form of the slot or rail can also have a sawtooth function.

FIGS. 9 thru 16 show various further embodiments of a frame section for a stretcher according to the invention. In these examples, the frame section comprises a hard extrusion profile D that forms the inside of the frame section. The harder extrusion profile serves as the framework of the stretcher and provides its strength and stiffness. The same can be said of the shape of the hard extrusion profile.

A softer extrusion profile B is fitted into extrusion profile B, in this example by means of a click or slide connection. The canvas A is pulled around the softer extrusion profile B, tensioned and fastened with staples or other fasting materials E. Besides fastening the canvas, the softer extrusion profile also has a further function. The flexibility of the softer material provides the raised edge of extrusion profile B with the flexibility required for tensioning the canvas. The softer extrusion profile B comprises a flexible wall that can accommodate changes in tension in the canvas, shown in the figure by means of the double arrow T. The wall has a height X that can hinge around a hinge point or hinge line S.

A further aspect is added to this in the embodiments show in FIGS. 11, 12, 15 and 16. In these embodiments, the stretcher is fitted with an adjustment pin F. By moving pin F, the flexible wall of extrusion profile B can be pushed outward to further tension the canvas. FIG. 17 shows a stretcher according to the embodiment of FIG. 13. FIG. 18 shows a rear view of a stretcher according to the invention provided with staples E.

FIG. 19 shows a further example. In this example, the pin or wedge F has a pitched surface I in order to ensure a good lever effect for moving the edge of extrusion profile B. The pin F and/or the extrusion profile D are also provided with friction or sawteeth elements J and W to lock or hold the position of the then. The extrusion profile B is provided with a stop N to prevent significant inward movement of the canvas. The extrusion profile B is provided with a slit M.

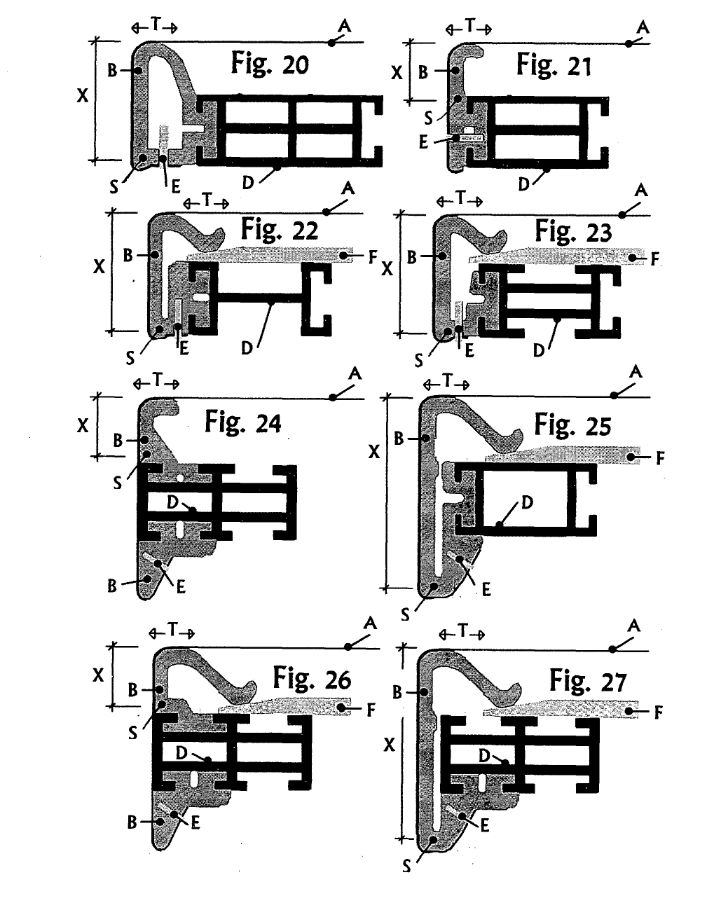

FIGS. 20 thru 27 show various further embodiments of a frame section for a stretcher according to the invention.

FIG. 24 shows an embodiment in which three extrusion profiles are used. This could offer certain advantages. Extrusion profile D is made of a hard material, the top extrusion profile B of a firm yet flexible material, the bottom extrusion profile of a material that is ideal for the use of staples.

FIGS. 28 and 29 illustrate the flexible character of the flexible wall. B1 shows the wall of the softer extrusion profile under a low canvas tension and B2, represented by a dotted line, shows the wall of the softer extrusion profile under high canvas tension. The harder extrusion profile D undergoes little to no change in shape.

FIG. 30 shows a further embodiment. In this embodiment, the frame section is fitted with an adjustment mechanism; in this case a threaded element K fitted with a screw L. By tightening or loosening screw L, it is possible to move the flexible outer wall of extrusion profile B.

FIGS. 31 and 32 show the effect of the flexibility of extrusion profiles B and the strength of extrusion profiles D. FIG. 31 schematically shows the movement of conventional stretchers. These contain four predominantly rigid framework sections. Conventional stretchers tension the canvas by pulling at the corners. As a result, the predominantly rigid framework sections warp along the line O. The corners move sideways, but due to the tension on the canvas, the distance between two opposite sides remain more or less the same (or is even shortened). The framework sections, which are relatively long, are rigid at right angles to the bar, as the thickness of the bar allows little to no change, resulting in a high warp risk, resulting in warping of the sides. In FIG. 31, P shows the outer surfaces of the stretcher without tension on the canvas, while P′ shows the outer surfaces while the canvas is under tension. The arrows represent the movement of the frame sections and thus the canvas. In FIG. 31, the corners move outward and the framework sections warp along the line O. This results in a very unbalanced tension distribution across the canvas and deformation of the canvas, which causes problems in particular in case of large canvases.

FIG. 32 shows the same situation when use is made of a flexible outer wall, a hard inner profile D and a softer outer profile B. The thickness of a frame section can now be adjusted to the tension as the flexible wall of the softer section B can move around hinge lines S, S′, S″, S′″ etc., while the inflexible framework formed by the harder inner profile D can retain its shape, ensuring that the outward movement of the canvas is evenly distributed over the frame sections. The frame sections will not warp and the tension distribution over the canvas is improved. If the frame sections D were to warp, distortion along the canvas surface is compensated by using the pin or adjustment screw to move the inner surfaces outward and thus restore a straight canvas line. The fact that the frame sections do not warp allows for firmer framework. The invention can be used for all sizes, including for relatively large stretchers with sides longer than 1 m.

FIGS. 33 and 34 show further embodiments of a frame section according to the invention. In these figures, extrusion profile B contains an element fitted with slits Q. This element is slid into a protruding rail of extrusion profile D. The light clamping effect of the form and the material means that extrusion profiles D and B lock into one another. They can be separated by a movement whereby extrusion profile B is slid out f extrusion profile D. Such a movement is, however, not possible in case of a composite stretcher. Separation through canvas tension is thus not possible. U is the edge of the wall over which the canvas is stretched. R is protruded rail of extrusion profile D. Z shows the press direction of pin F.

FIG. 35 shows a further embodiment of a stretcher according to the invention. This embodiment resembles the embodiment of FIG. 19, with the difference that extrusion profile B now extends on both sides of profile D.

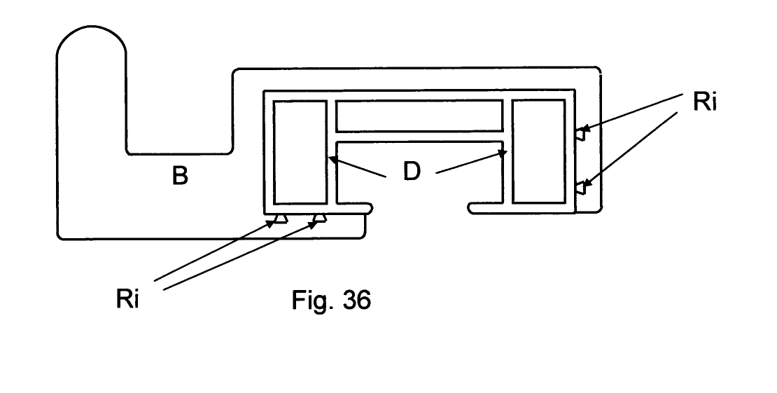

FIG. 36 shows a further embodiment. In this embodiment, the two profiles D and B are co-extruded. The hardware profile, made of aluminium in this example, is provided with corrugations Ri embedded in the softer profile B. These corrugations provide a bond with the softer profile B during the co-extrusion process. This prevents separation of the softer profile from the harder profile. The corrugations Ri are preferably laid out in rows, as the pairs shown in this example, whereby the softer material of the softer profile B, made of PVC in this example, is enclosed in two corrugations. The corrugations are preferably tapered, thereby strengthening their bonding effect.

Briefly summarised, the invention can be described as follows:

A stretcher comprises frame sections. The frame sections comprise two extruded profiles (B, D) whereby the outer profile is made of a softer material than the inner profile. The inner, hard profile (D) gives firmness to the stretcher, while the softer profile (B) provides flexibility. The softer profile is preferably fitted with a flexible wall that can hinge around a hinge line. This makes it possible to accommodate variations in canvas tension, while at the same time ensuring a strong stretcher. The frame sections are preferably fitted with adjustment mechanisms (F, L).

Obviously, the invention allows for numerous variations that are not limited to the examples given above.

Some examples show a pin can be used to adjust the canvas tension. The adjustment mechanism could also be an adjustment screw or other mechanism, as shown in FIG. 30. These adjustment mechanisms can be adjusted by hand. The adjustment mechanisms can also be electronic, for example as a piezo-electric element or a hydraulic element with an electric drive.

The frame sections are preferably fabricated as a single unit. In case of very large stretches, however, the frame sections could also comprise several lengths. This requires a connecting piece with which to join two frame section parts.

The invention is also embodied in a method whereby the extrusion profiles are fabricated as a frame section.

1. A stretcher for painting canvas, comprising a number of frame sections,
each frame section including:
at least a first profile and
a second profile made of extruded material, whereby the materials of those profiles differ from one another, the profiles are locked into one another in longitudinal direction, the first profile extends beyond the outer edge of the stretcher and the second profile is positioned more inward, whereby the first profile is made of a softer material than the second profile.

2. The stretcher of claim 1, wherein the frame sections are produced by means of co-extrusion.

3. The stretcher of claim 1, wherein the second profile is provided with corrugations embedded in the first profile.

4. The stretcher of claim 3, wherein the corrugations are formed in rows.

5. The stretcher of claim 3, wherein the corrugations are tapered.

6. The stretcher of claim 1, wherein the profiles are extruded separately.

7. The stretcher of claim 1, wherein the first profile contains an edge along which the canvas is led and a deformable wall.

8. The stretcher of claim 7, wherein the stretcher is fitted with adjustment mechanisms for moving the deformable wall in a direction at right angles to the stretcher to enable movement of the deformable wall.

9. The stretcher of claim 1, wherein a profile is provided with a slit or protruded rail for joining with part of the other profile.

10. The stretcher of claim 9, whereby the inside space is fitted with sawteeth to ensure a strong bond in the slit.

11. The stretcher of claim 8, wherein the adjustment mechanism contains a pin.

12. The stretcher of claim 1, wherein the pin is provided with notches to fix the position of the pin.

13. The stretcher of claim 8, wherein the adjustment mechanism contains an adjustment screw.

14. The stretcher of claim 13, wherein the adjustment screw is connected to the second profile.

15. The stretcher of claim 1, wherein the extrusion material of the second profile is aluminium or an aluminium alloy, and the extrusion material of the first profile comprises plastic.

16. The stretcher of claim 1, wherein one of the profiles is made of PVC.

17-18. (canceled)

19. A frame section for a stretcher comprising:
at least a first profile and
a second profile,
wherein:
the materials of the first and second profiles differ from one another,
the profiles are locked into one another in a longitudinal direction, and
the first profile is made of a softer material than the second profile.

20. The frame section of claim 19, wherein the first and second profiles are configured to accommodate an adjustment element that exerts a force to move a portion of the first profile away from the second profile.

21. A method comprising:
extruding a first member of a frame section of a canvas stretcher, and
extruding a second member of the frame section that is configured to receive the first member such that the first and second members are locked into one another in a direction of extrusion,
wherein the first member is made of material that is more pliable than material of the second member.

22. The method of claim 21, wherein the first and second members are concurrently extruded, and the method includes locking the first and second members together as they are extruded.
